(19) United States
(12) Patent Application Publication
(10) Pub. No.: US 2012/0113028 A1
(43) Pub. Date: May 10, 2012

(54) METHOD FOR DETECTING AND LOCATING KEYPRESS-EVENTS ON TOUCH- AND VIBRATION-SENSITIVE FLAT SURFACES

(75) Inventors: Randal J. Marsden, Edmonton (CA); Steve Hole, Edmonton (CA)

(73) Assignee: CLEANKEYS INC., Edmonton (CA)

(21) Appl. No.: 13/171,124

(22) Filed: Jun. 28, 2011

Related U.S. Application Data
(60) Provisional application No. 61/359,235, filed on Jun. 28, 2010.

(51) Int. Cl. G06F 3/041

(52) U.S. Cl. 345/173

(57) ABSTRACT

Systems and methods for enabling use of vibration sensors attached to the touch-sensitive surface to both detect and locate finger contact events on the surface. The invention specifically discriminates between intentional typing events and casual or unwanted contacts resulting from normal typing actions, thus allowing the user to rest their fingers on the keys and allowing them to type as they would on a regular keyboard. Signals from both touch and vibration sensors are translated into a series of input events. Input events are then temporally correlated to determine the location of the finger contact and activation of the corresponding key. Correlated events are then filtered to remove unwanted events and resolve ambiguous or contradictory results.

### PRIORITY CLAIM

This application claims the benefit of U.S. Provisional Application Ser. No. 61/359,235, filed Jun. 28, 2010, which is incorporated by reference.

### FIELD OF THE INVENTION

The invention relates to a smooth, solid touch- and vibration-sensitive surface that is easy to clean and that allows the user to rest their hands or fingers on the surface without causing an event actuation. More specifically, the surface may be used as a computer keyboard for inputting text and commands.

### BACKGROUND OF THE INVENTION

The origin of the modern keyboard as the primary method for inputting text and data from a human to a machine dates back to early typewriters in the 19^{th} century. As computers were developed, it was a natural evolution to adapt the typewriter keyboard to be used as the primary method for inputting text and data. While the implementation of the keys on a typewriter and subsequently computer keyboards has evolved from mechanical to electrical and finally to electronic, the size, placement, and mechanical nature of the keys themselves have remained largely unchanged.

Computers, and their accompanying keyboards, have become pervasive in environments across numerous industries, many of which have harsh conditions not originally accounted for in the computer and keyboard designs. For example, computers are now used in the kitchens of restaurants, on production floors of manufacturing facilities, and on oil drilling rigs. These are environments where a traditional keyboard will not remain operational for very long without cleaning, due to extreme contamination conditions.

To overcome the problem of cleanability of the keyboard, it seems intuitive that if the keyboard surface itself could be a flat, or nearly flat, surface, then wiping the keyboard to clean it would be much easier. This means, however, that an alternative to the physical mechanical or membrane keys of the keyboard would need to be found.

In partial response, new computer form factors have evolved to eliminate external keyboards entirely, consisting solely of a touch-sensitive flat display screen with a software-based “virtual” keyboard for data entry. Touch screen virtual keyboards are difficult to use at high speed for typists who are trained to rest their hands on the keyboard, as the act of resting results in unwanted key activations from the keyboard.

Therefore, there is a need to improve on the above methods for keyboard entry in a way which is easy to clean, allows the user to feel the keys, allows the user to rest their fingers on the keys, requires the same or less force to press a key as on a standard keyboard, is responsive to human touch, and allows the user to type as fast as or faster than on a conventional mechanical keyboard.

### SUMMARY OF THE INVENTION

The present invention provides systems and methods for enabling use of vibration sensors attached to the touch-sensitive surface to both detect and locate finger contact events on the surface. The invention specifically discriminates between intentional typing events and casual or unwanted contacts resulting from normal typing actions. This approach makes it possible for the user to rest their fingers on the keys, allowing them to type as they would on a regular keyboard.

As the user places their fingers on the surface, the touch sensors (one or more per key) and vibration sensors are simultaneously activated. Signals from both the touch and vibration sensors are translated into a series of input events. Input events are then temporally correlated to determine the location of the finger contact and activation of the corresponding key. Touch events without a corresponding “tap” (i.e., vibration) are ignored. Correlated events are then filtered to remove unwanted events and resolve ambiguous or contradictory results. For example, the present invention is able to detect the difference between an intentional key press and when a user has set their hands down on the keyboard in preparation for typing.

The present invention has significant advantages over traditional touch sensitive input devices. One such advantage is that the user can rest their fingers on the keys without causing a key actuation to occur. Another is that the user can type by touch without having to look at the keyboard.

### BRIEF DESCRIPTION OF THE DRAWINGS

Preferred and alternative examples of the present invention are described in detail below with reference to the following drawings:

FIG. 1 is a hardware block diagram showing the typical hardware components of a system formed in accordance with an embodiment of the present invention;

FIGS. 2A through 2E is a flowchart of an exemplary process performed by the system shown in FIG. 1 to detect and locate finger presses on the surface and to calculate the corresponding keyboard input keys;

FIG. 3 shows an embodiment of a software algorithm to implement the method of the present invention in order to detect valid key activations and generate touch and tap input events from tap (vibration) sensor data;

FIGS. 4A through 4B show an embodiment of a software algorithm to perform touch and tap input event correlation; and

FIGS. 5A through 5D show an embodiment of a software algorithm to perform filtering of correlated input events.

### DETAILED DESCRIPTION OF THE PREFERRED EMBODIMENT

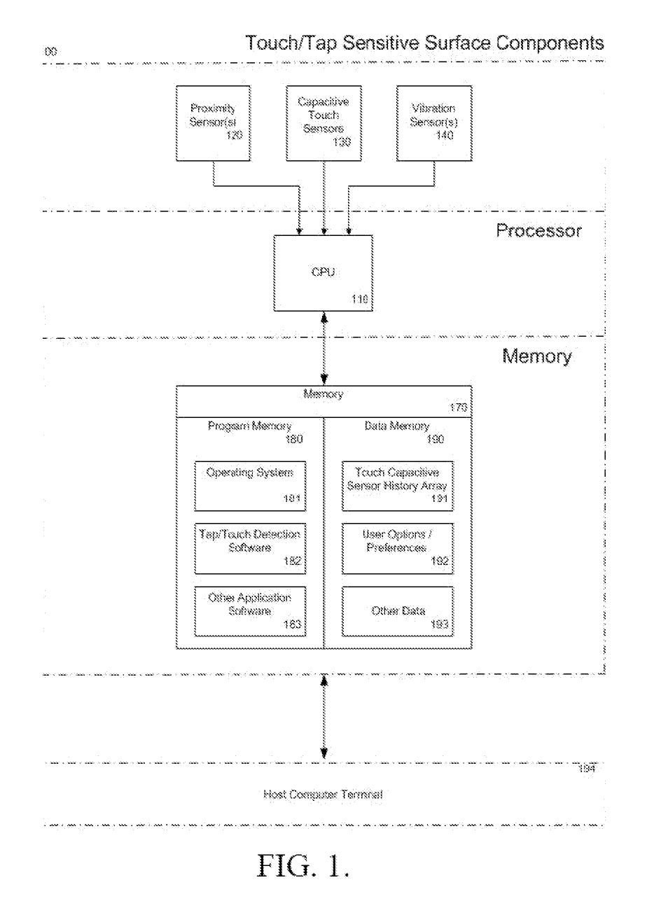

FIG. 1 shows a simplified block diagram of the hardware components of an embodiment of a touch/tap-sensitive keyboard device 100. The device 100 includes a planar surface that houses proximity sensor(s) 120, capacitive touch sensors 130, and a vibration sensor(s) 140. The sensor components 120, 130, and 140 provide input to a CPU 110 (processor) 110. The CPU provides notification of contact events when the keyboard surface is approached or touched by the user's hands based upon interpretation of raw signals received from the sensor components 120, 130, and 140.

Memory 170 is in data communication with the CPU 110. The memory 170 includes program memory 180 and data memory 190. The program memory 180 includes operating system software 181, tap/touch detection software 182 and other application software 183. The data memory 190 includes a touch capacitive sensor history array 191, user options/preferences 192, and other data 193.

As the user's fingers come into contact with the flat planar surface, the capacitive touch sensors 130 are asserted. Periodically, the CPU 110, executing the keyboard operating system software 181, collects the raw sensor data from the touch 130 and tap 140 sensors and stores the raw sensor date in the data memory 191.

In a separate thread of execution, the CPU 110 continuously executes the tap and touch detection and location software (algorithm) 182 described herein to process the sensor data produced by the keyboard into a sequence of key “up” and “down” states. Each execution of the algorithm constitutes a “cycle”, which is the basic timing unit for the algorithm. When a valid key activation is detected, the CPU 110, supported by the touch/tap detection software 182, performs an algorithmic analysis of the sensor data contained in the memory 191 to determine which area of the planar surface was touched and tapped on. When a valid tap/touch location is calculated by the algorithm 182, it is passed to the keyboard operating system software 181 where it is mapped into a specific keyboard function code. Typical keyboard functions include standard keyboard alphanumeric keys, function and navigation keys. The mapped function code is then sent to a connected host computer terminal 194 through a standard peripheral/host interface like USB or PS/2.

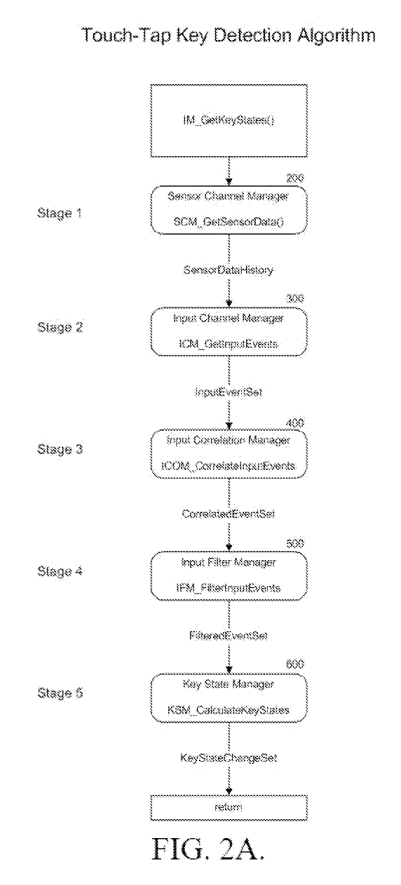

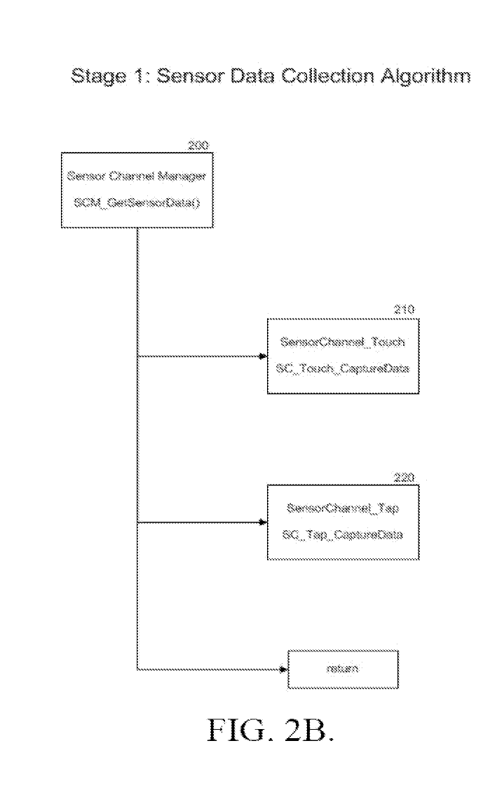

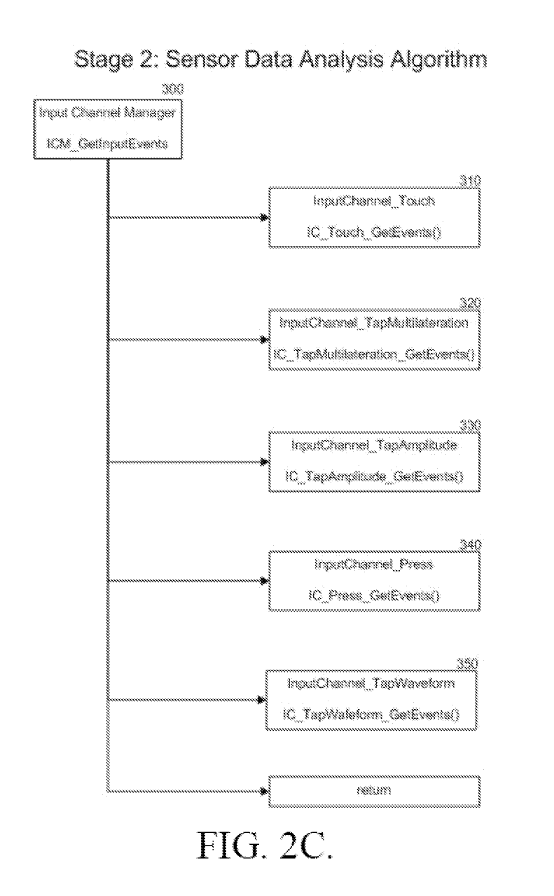

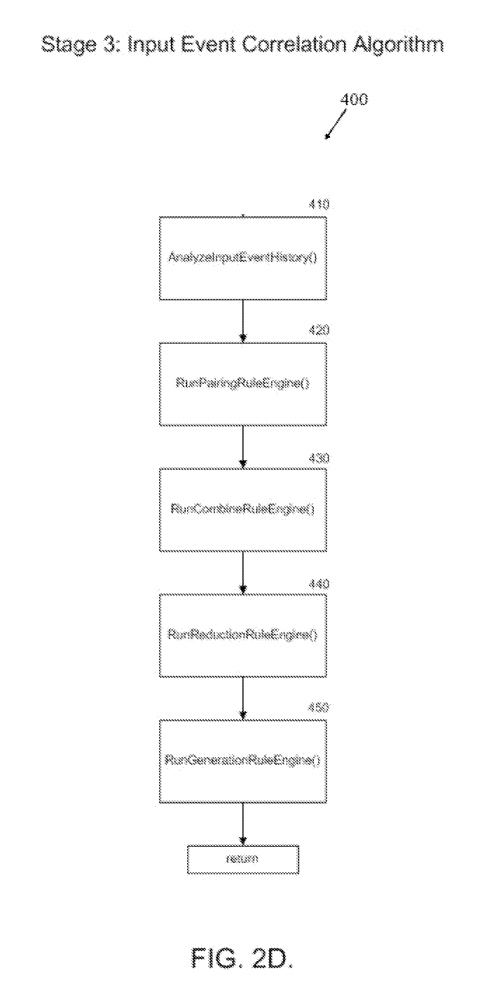

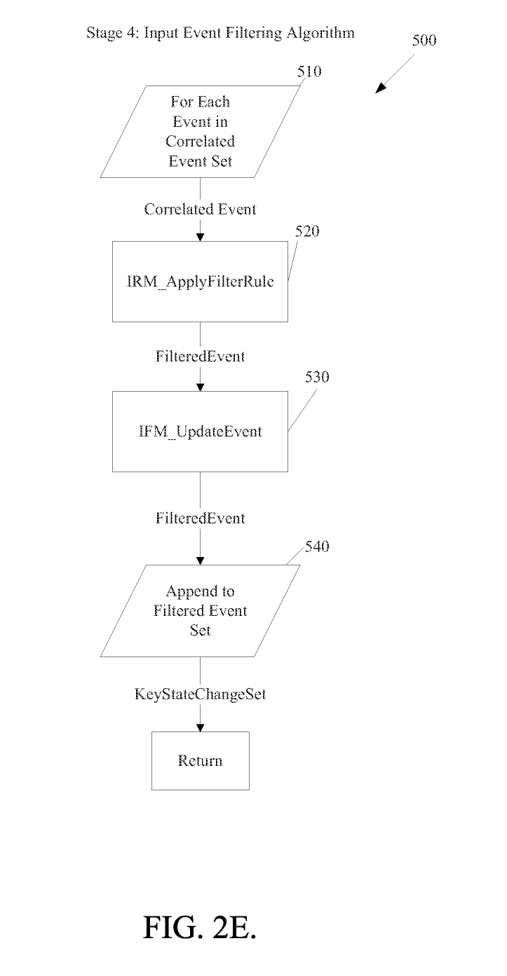

FIG. 2A shows a flowchart of an embodiment of software to implement an exemplary method of locating user key activations on the touch and tap sensitive surface. The method is broken into five distinct stages, each directed by a separate system software component called a “Manager”:
Stage 1 sensor data collection 200;
Stage 2 sensor data analysis and input event generation 300;
Stage 3 input event correlation 400;
Stage 4 input event filtering 500; and
Stage 5 key state change analysis 600.

At Stage 1 (FIG. 2A 200), data is collected from the touch and tap (vibration) sensor(s) 140 and placed into memory for future processing. FIG. 2B shows a flowchart of an embodiment of a software algorithm for collecting and summarizing the signal values from the touch and tap sensor(s). The CPU 110 is controlled by a SensorChannelManager and invoked through an SCM_GetSensorData method 200. The SensorChannelManager 200 invokes one or more SensorChannel components that collect, summarize and store sensor data. A SensorChannel applies a specific collection and summary algorithm to sensor signals to produce a touch or tap sensor data record. Sensor data records are stored with an associated time stamp for future processing in the next stage.

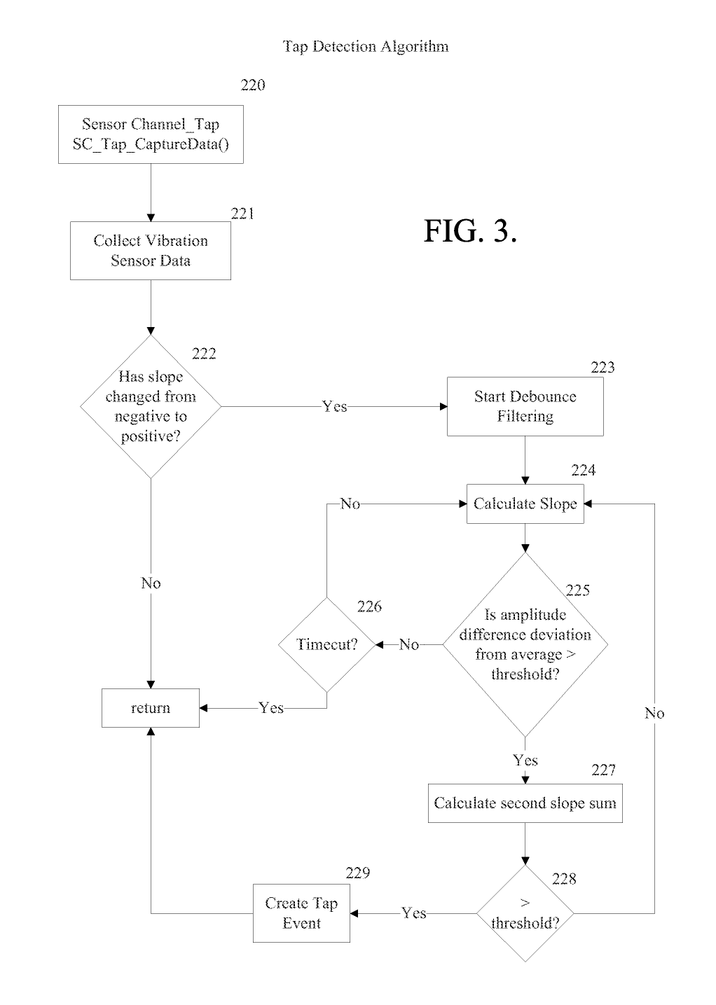

A Tap SensorChannel invoked by the SC_Tap_CaptureData method 220 identifies the temporal occurrence of a finger initiated tap on the surface. FIG. 3 shows a flowchart of an embodiment of a software algorithm for detecting a tap event. The Tap sensor channel method 220 samples the tap analog data stored in the vibration sensor data records 221 for the current cycle. The collected set of data is represented as a waveform for each vibration sensor with a start time fixed at the start time of the current cycle. If the difference between a collected signal value and the average signal exceeds a threshold (difference deviation from average) 222 then the corresponding point in the signal waveform represents a possible event. The algorithm initiates two state machines that execute simultaneously. The first suppresses (filters) multiple tap events from being generated by reverberations of the original tap, see block 223. The second attempts to calculate the exact time of occurrence of the tap by detecting the first minima (the lowest point) on wave form that exceeds a threshold. The temporal location of the minima is detected by calculating the “second slope sum” of the wave form at each sample point. The CPU calculates the instantaneous slope of the wave form line at each sample point 224. If the slope at the sample point changes from negative (downward) to positive (upward) then the sample represents a possible minima and the sample time is the time of the tap event. The CPU then detects if the minima qualifies as a true minima. It calculates the “first slope sum” for the sample point by adding the slopes of the five previous sample points to the current sample point slope. The system then calculates the “second slope sum” by adding the first slope sums of the five previous sample points to the current sample point first slope sum, see block 227. The result is an amplification of the slope difference at the sample point which is readily comparable to thresholds and identification of major slope reversals (descending to ascending) typical of a minima, see decision block 228. If the threshold is exceeded then a tap event is generated and stored as a Tap sensor data object by the channel, see block 229.

At stage 2 (FIG. 2A 300), historical sensor data is analyzed to produce a stream of “input event” objects that represent a possible key activation on the surface. FIG. 2C shows a flowchart of an embodiment of a software algorithm for analyzing sensor data and creating input events. The CPU 110 is controlled by an InputChannelManager and invoked by an ICM_GetInputEvents method 300. The InputChannelManager 300 invokes one or more InputChannel components that analyze sensor data collected summarized and stored in stage 1. An InputChannel applies a specific analysis algorithm to sensor data to detect the conditions for and create an input event.

A Touch InputChannel process invoked by the IC_Touch_GetEvents method 310 looks for user touch input events. The CPU 110 executing the Touch InputChannel process analyzes stored touch capacitive sensor data, creating a Touch input event for each signal that exceeds a threshold value.

A Tap multilateration InputChannel invoked by the IC_TapMultilateration_GetEvents method 330 uses the relative time difference of arrival (TDOA) of a tap event at each vibration sensor to calculate the coordinate of the tap location on the keyboard and create an input event. The CPU 110 uses the technique of multilateration to triangulate the source location of a signal given three or more detectors of that signal at a fixed known location. The CPU 110 using multilateration takes the relative arrival time to each accelerometer stored in the tap event record and calculates the most likely location on the keyboard that the tap has occurred, based on the experimentally measured speed of propagation of the vibration wave on the surface. The keys that fall near the calculated tap location are chosen as candidate keys in the generated input event.

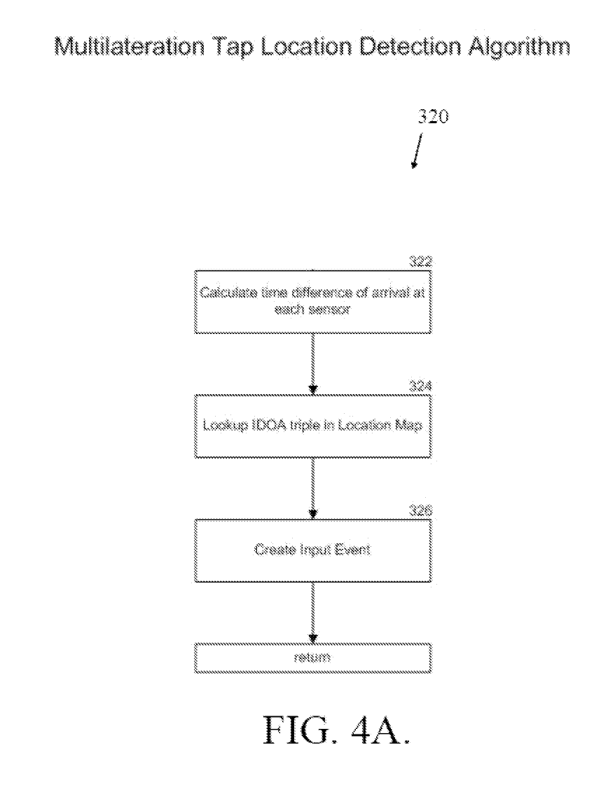

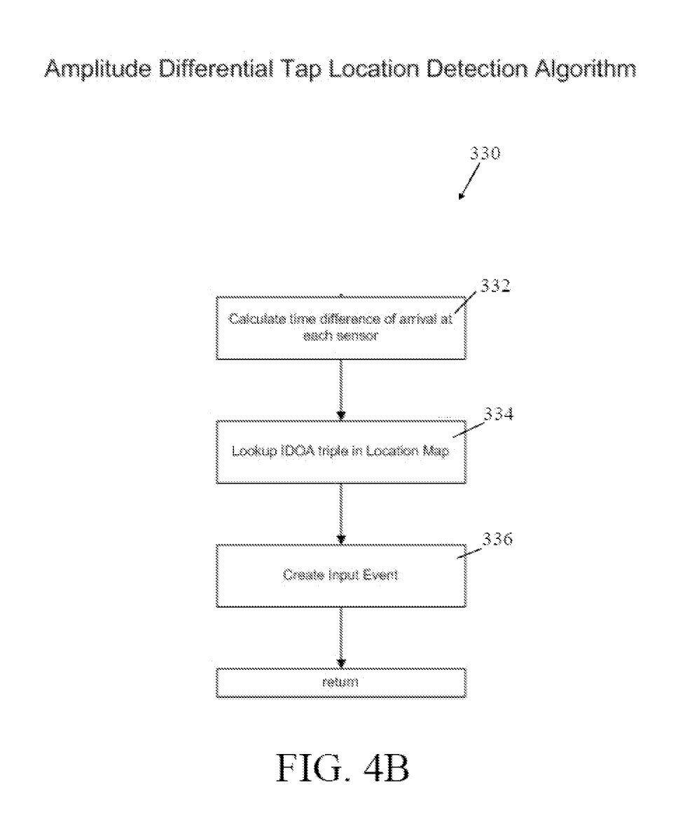

FIG. 4A shows a flowchart of an embodiment of a software algorithm for tap multilateration. The time deltas or difference in arrival time of the tap event at the each of the sensors are calculated at block 322. The acoustic wave generated from a tap on the surface travels at a near constant speed through the surface material to each sensor. In practice, the propagation speed of the wave is not constant, varying with location on the surface and between individual instances of the embodiment. To accommodate the variance, the process may use the relative arrival times as indexes into a location lookup table that maps triples of relative arrival times to key coordinates, see block 324. The values of the table are derived empirically by repetitive test and measurement on the surface. The process selects the set of records that most closely match the relative time of arrival, as exact matches are unlikely and unreliable. The set of records define a regional location containing a set of candidate keys that correspond to the statistical error range produced by a nonconstant speed. Candidate keys within the region have an increasing probability gradient from the edges to the center of the region, with the most likely keys in the middle of the region. The process 320 creates an input event with the candidate keys specified by the mapped region, see block 326.

In one embodiment, the Tap multilateration algorithm includes a method for detecting and eliminating external (off keyboard) vibrations from consideration as a tap event. A common problem occurs when a user is moving their fingers on the surface of the keyboard, but not tapping, at the same time as an external vibration source is activating the vibration sensors. Unless the external tap is filtered, this leads to a false positive as the vibration is correlated to a change in the touch sensors. It is therefore important to be able to detect external vibrations and filter them out. The Tap Multilateration algorithm uses the characteristic of the physical structure of the surface to detect an external tap. Any external tap causes both the left and right accelerometer to fire before the center accelerometer because the external vibration is carried through the left and right feet of the keyboard to the left and right accelerometers before they propagate to the center detector—the center detector is last. If the conditions for both approaches are met, then the signal has a high probability of originating as an external vibration and can be eliminated as a tap event.

A Tap Amplitude InputChannel process invoked by the IC_TapAmplitude_GetEvents method 330 uses the relative differences in tap signal amplitude to calculate the coordinate of the tap location on the keyboard and create an input event locate. An amplitude variance algorithm takes the relative amplitudes recorded by each of the accelerometers to triangulate and calculate the coordinates of the tap location on the keyboard, based on an experimentally measured linear force response approximation of the vibration wave in the surface material. The keys that fall near the calculated amplitude tap location are chosen as candidate output keys.

In one embodiment, the Tap amplitude differential process 330 includes an approach for detecting and disqualifying external vibrations as tap events. When a tap occurs on the surface of the keyboard, except for a few known coordinates on the surface, there is usually a large differential in the amplitudes detected by each accelerometer a characteristic that is the basis for the tap amplitude differential process 330. However, when an external tap occurs, the amplitudes detected by each sensor are often very close in amplitude and can be used to identify the tap as a potential external tap and disqualifying it from further consideration.

FIG. 4B shows a flowchart of an embodiment of a software algorithm for tap amplitude differential (330). The amplitude difference of the tap event at the each of the sensors are calculated, see block 332. The acoustic wave generated from a tap on the surface propagates through the surface material to each sensor with a near linear attenuation (force degradation) of the signal amplitude. The amplitude differential algorithm 330 uses the relative amplitudes stored in the tap event record and calculates the most likely location on the keyboard that the tap has occurred based on a linear force response approximation an assumed linear constant attenuation in signal amplitude caused by absorption in the transmitting material as the signal wave crosses the surface. The further the signal source from signal detector, the smaller the signal. In practice, the attenuation of the wave is not constant, varying with location on the surface and between individual instances of the embodiment. To accommodate the variance, the process may use the amplitude values as indexes into a location lookup table that maps triples of amplitude differentials to key coordinates, see block 334. The values of the table are derived empirically by repetitive test and measurement on the surface. The process selects the set of records that most closely match the amplitude differential, as exact matches are unlikely and unreliable. The set of records define a regional location containing a set of candidate keys that correspond to the statistical error range produced by a non-constant attenuation. Candidate keys within the region have an increasing probability gradient from the edges to the center of the region, with the most likely keys in the middle of the region. The process 330 creates an input event with the candidate keys specified by the mapped region at block 336.

A Press InputChannel process invoked by the IC_Press_GetEvents method 340 detects input events that occur when a resting finger is pressed hard onto the keyboard surface. It recognizes and remembers the touch signal strength of the resting finger and measures the difference between the resting finger and the pressed finger. If the signal strength difference exceeds a threshold value then an input event is generated.

A Tap Waveform InputChannel process invoked by the IC_TapWaveform_GetEvents method 350 compares the shape of the tap signal waveform to recognize known shapes and thus to calculate the coordinate of the tap location on the keyboard and create an input event. Exemplary vibration waveform are recorded and stored for each location on the surface in multiple use environments. In one embodiment, each of the recorded waveforms is analyzed and a number of unique characteristics (a “fingerprint”) of the waveforms are stored rather than the complete waveform. The characteristics of each user-initiated tap occurrence are compared with stored characteristics for each key in the database and the best match is found. Characteristics of the waveform that can contribute to uniquely identifying each tap location include, but are not limited to the following: the minimum peak of the waveform; the maximum peak of the waveform; the rate of decay of the waveform; the standard deviation of the waveform, the Fast Fourier Transform of the waveform; the average frequency of the waveform, the average absolute amplitude of the waveform; and others.

At stage 3 (FIG. 2A 400), input events are correlated into temporally and spatially related events that define a key activation based on mutual agreement on the location, content, and duration of the activation. FIG. 2D shows a flowchart of an embodiment of a software algorithm for correlating input events. The system is controlled by an InputCorrelationManager and invoked by an ICOR_CorrelateInputEvents method 400. Correlation coalesces related input events produced by the touch, press, and tap input channels into a single correlated input event. Correlation proceeds in six distinct phases:

Correlation Phase 1, shown in block 410, analyzes the input events to determine how many events are available in history and what their relative time difference is from each other;

Correlation Phase 2 shown in block 420, generates pairs of event (duples) that are possible combinations;

Correlation Phase 3, shown in block 430, generates tuples (three or more events), from the set of calculated duples;

Correlation Phase 4, shown in block 440, reduces the sets of candidate tuples and duples, eliminating any of the combinations that are not fully reflexively supporting; and

Correlation Phase 5, shown in block 450, generates new correlated input events from the set of tuples, replacing the individual input events that make up the tuple with a single correlated input event.

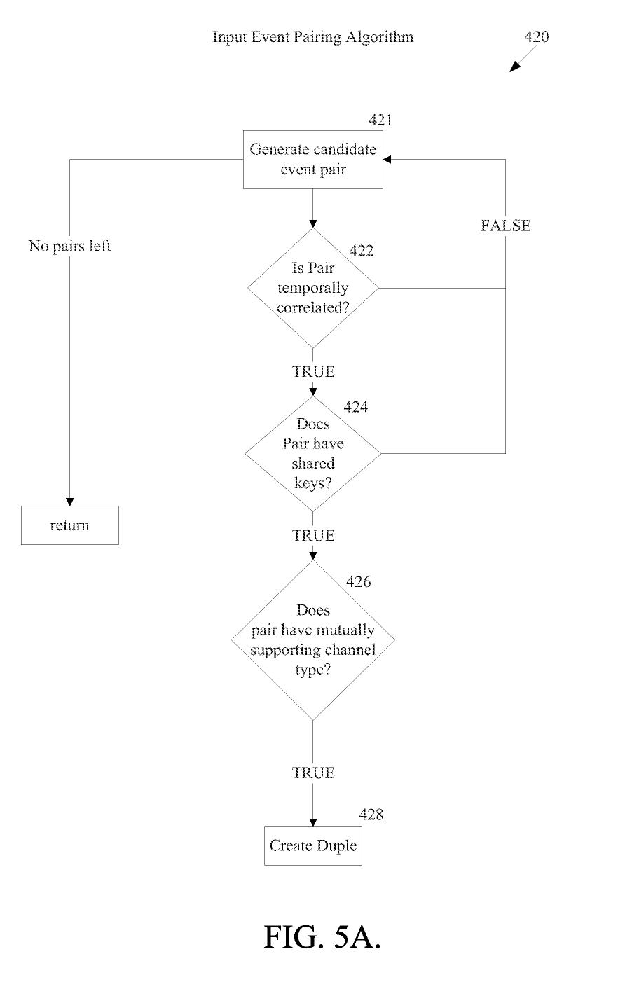

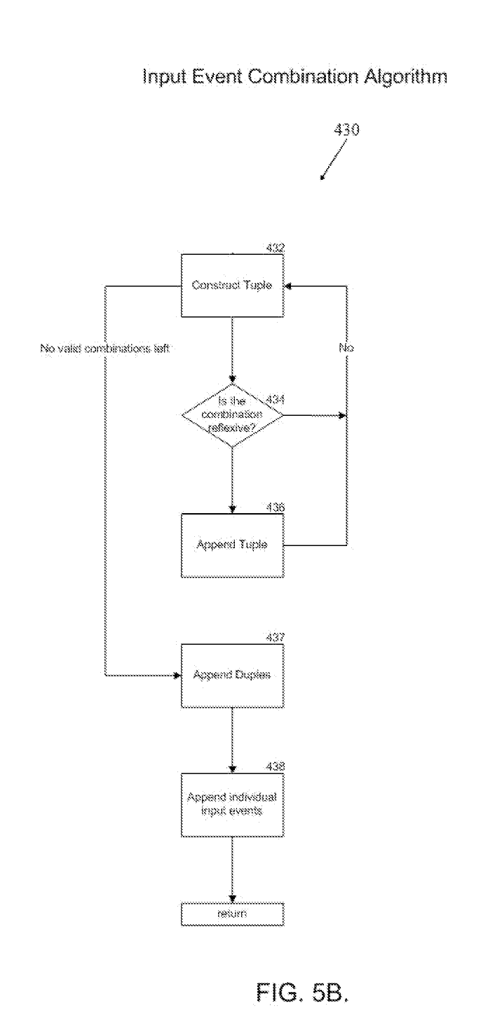

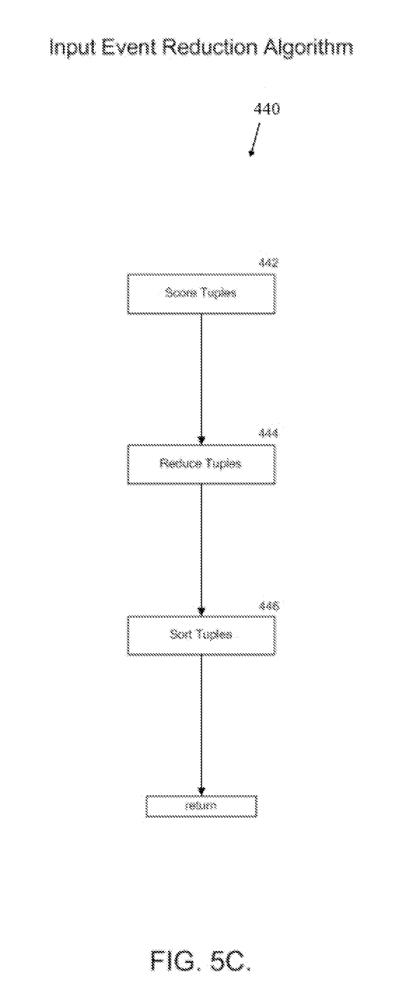

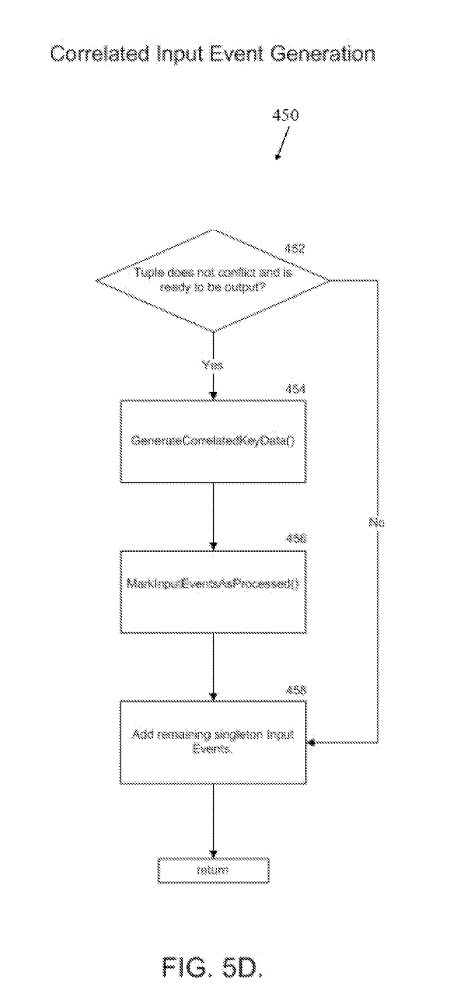

The InputCorrelationManager process 400 requests historical input event data from the InputEventManager, redundant events are eliminated from the input event history, and new correlated input events are created. All input events that contributed to a correlated event are removed from the input event history database. FIGS. 5A through 5D show the correlation process in detail.

FIG. 5A shows an embodiment of a phase 2 input event pairing algorithm. A RunPairingRule method 420 generates a set of input event pair combinations (duples) at block 421 and then applies a series of rules to evaluate them for potential as a correlated pair. Rules for pair correlation include: temporal correlation (block 422) checks to see that the events are near to each other in time; key intersection correlation (block 424) checks to see that the input events share candidate keys; and channel correlation (block 426) checks to ensure that the input channels that generated the events are compatible. The results of the rule executions are logically combined into an overall score for the pair. If the score exceeds a threshold, then the duple is a valid correlation pair and is added to the output list of duples in block 428.

FIG. 5B shows an embodiment of a phase 3 input event combination algorithm. Duples produced by the pairing algorithm 420 are further combined in block 430 into combinations of three or more events creating a series of “tuples”. Each tuple is evaluated in block 432 to ensure that the combination of input events within the tuple is fully reflexive for each contributing duple. For example, given three events A, B, and C, the tuple ABC is valid if correlated duples exist AB, BC, and AC. The result of tuple evaluation is appended to the list of valid duples at block 436. Original duples are appended at block 437 and uncorrelated single events at block 438, resulting in a list of all possible correlated events. Tuples with a larger number of contributing events have a stronger correlation and therefore a (generally) higher score.

FIG. 5C shows an embodiment of a phase 3 input event reduction algorithm (block 440). Tuples, duples, and singleton events are evaluated an assigned a numeric score based on the strength of the correlation and reliability of the input event, see block 442. If an input event is a member of two or more tuples or duples, then the tuple or duple with the highest score claims the event and the lower scored tuples or duples are eliminated (reduced) from the set of candidates 444. Reduction continues at block 444 until the set of remaining tuples, duples, and singleton events contain no shared single input events, having a unique input event membership from any other combination. The remaining tuple, duples and singleton events are then sorted in descending score order 446.

FIG. 5D shows an embodiment of phase 4 correlated input event generation (block 450). Each element of the set of reduced tuples, duples, and singleton events are tested to see if they can be released at block 452, with those that have constraints deferred for later processing. Those that pass block 452 are translated into a new correlated input event at block 454. The original input channel generated input events that contributed to the tuples, duples, and singleton events are marked as processed at block 456 and so that they will not be processed again. The resulting set of correlated events represents the real candidates for key activations by the user.

At stage 4 (FIG. 2A 500) the stream of correlated events is analyzed to remove unwanted events and resolve ambiguous key candidates within the events. FIG. 2E shows a flowchart of an embodiment of a software algorithm for filtering input events. The CPU 110 is controlled by an InputFilterManager and invoked by an IFM_FilterInputEvents method 500. The InputManager invokes an InputFilterManager to eliminate unwanted correlated events from the input event stream and to reduce the candidate keys within the events to a single key. The InputFilterManager passes a finalized sequence of input events to a KeyStateManager for processing into key activation codes suitable for transfer to the host computer operating system.

The embodiment implements a rule execution engine for sequentially applying filter rules to a correlated input event set. Each filter is defined as a rule that operates on a specific aspect of the input event set, changing scores and updating the long term state of the InputManager system. Filters have access to the complete set of input events and are allowed to either remove the event from processing consideration and/or reduce the set of candidate keys within the event. Filters are also allowed to access and update the long term (multi-cycle) state of the input manager in support of long-term trend and behavioral analysis. The long-term state feeds back into the other stages of input event processing.

A set of correlated input events calculated by the InputCorrelationManager is passed to the InputFilterManager through the IFM_FilterEvents (block 500) method. The rule engine applies filter rules to each element of the input event set at block 520 in rule registration order. The result of rules is a set of modifications that are applied to the (filtered) input events in block 530, and which are output at block 540 to the next stage of processing. The embodiment implements a number of rules that address special cases for key input.

The embodiment includes a vertical touch filter rule. The vertical touch filter adjusts key probabilities for events with candidate keys that are vertically adjacent. As the user types on the keys above the home row, the finger extends and “lies out” on the keyboard, often activating both the intended key above the home row and the key immediately below it on the home row. The filter detects the signature of that situation and boosts the score of the topmost candidate key in the vertical adjacency as the one most likely typed. The boost factor is appropriately scaled such that a mistype between the vertically adjacent keys will not overcome a strong signal on the lower key. Thus the boost is small enough to favor the higher key, but not preclude selection of the lower key on a partial mistype onto the higher key boundary.

The embodiment includes a next key filter. The next key filter adjusts key probabilities for events with candidate keys that are ambiguous (equally scored). The filter uses a simple probability database that defines, for any given character, the most likely character to follow that character in the current target language. The current language is specified by target national language key layout of the keyboard. The next character probability has no relationship to words or the grammatical structure of the target language. It is the probability distribution of character pairs in the target language.

In one embodiment, a set down filter detects the signature of input events resulting from the user setting their hands into a rest position on the home row of the keyboard. “Setting down” can occur after a period of nonuse of the keyboard or during a pause in active typing. The filter eliminates the unwanted key activations that occur when the fingers make contact with the home row keys during the set down.

The set down filter is a multicycle filter that updates and relies on the long-term state of the input manager and input event queues. The set down filter processes in two distinct phases. Phase 1 is the detection phase, analyzing the correlated input event set looking for two or more simultaneous home row events that include multiple touch activations on the home row with a close temporal proximity. If a set down is detected, then the long term set down state is asserted for subsequent processing cycles and event translation to key activation. Once set down state is asserted, all input events are deferred until the set down is completed. Phase 2 is the completion phase, analyzing the deferred and new events and either qualifying or disqualifying events from participating in the set down. Set down termination is determined by any of: exceeding the maximum time duration for a set down, exceeding the maximum time duration between individual events within the set down (gap threshold) or detecting a non-home row input event. When any of the set down termination conditions are met, set down state is cleared by the filter. Any deferred events are either removed as part of the set down or released for processing. A set down detection does not always result in events being removed as set down completion may detect a termination that disqualifies home row events from participating in the set down.

In one embodiment, a typing style filter analyses the input events and long-term state of the InputManager to determine what the typing style of the current user is. It then sets various control parameters and long-term state values that feedback (are used by) other filters including set down and special case.

In one embodiment, a multiple modifier filter prevents the accidental activation of two or more modifier keys due to mistyping. The modifier keys typically occupy the periphery of the keyboard and are difficult to activate properly, particularly for a touch typist. The multiple modifier filter adjusts key probabilities for events with modifier keys, favouring the shift key as the most commonly used modifier, and lowering the score for the caps lock key as a rarely used key. The adjusted scores eliminate many of the inadvertent caps lock activations when reaching for a shift key.

At stage 5 (FIG. 2A 600), controlled by a KeyStateManager and invoked by a KSM_CalculateKeyStates method 600, the sequence of filtered events is converted into a stream of key up and down activations that are subsequently passed to a host computer.

While the focus of the embodiment described herein is for a keyboard application, someone skilled in the art will see that the system could also be successfully applied to any type of touch-screen device.

While the preferred embodiment of the invention has been illustrated and described, as stated above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method of detecting user input on a solid planar touch-sensitive surface to determine the location of a user's input, the method performed by a processor device being in signal communication with a plurality of sensors included in the touch-sensitive surface, the method comprising:
recording user touches of the touch-sensitive surface based on the plurality of touch sensors;
receiving a tap event signal from one or more vibration sensors coupled to the touch-sensitive surface based on a tap event sensed by the three or more vibration sensors; and
asserting a selection after the tap event signal is received based on the recorded user touches.

2. The method of claim 1, wherein asserting comprises transposing touch and vibration sensor signals into a series of discrete touch and tap sensor data events tied to a fixed temporal reference point.

3. The method of claim 2, wherein asserting comprises detecting the occurrence of a tap sensor data event signal based on the amplitude of signals from the one or more vibration sensors exceeding a fixed threshold value.

4. The method of claim 2, wherein asserting comprises detecting a time of occurrence of the tap sensor data event signal based on the location of the vibration waveform minimum using slope sum values.

5. The method of claim 2, wherein asserting comprises transposing sensor data events into a series of discrete input events, wherein the series of discrete input events are classified by a type associated with the sensor data, and wherein the series of discrete input events include a set of candidate keys and associated location information.

6. The method of claim 5, wherein asserting comprises triangulating physical coordinates of the tap sensor data event on the surface based on the difference of arrival times of a tap event at a plurality of vibration sensors.

7. The method of claim 6, wherein asserting comprises adjusting for differences in physical materials and assembly by mapping multilateration calculation results to known surface coordinates and selecting a set of possible coordinates, wherein the set of possible coordinates is assigned a probability between 0 and 1 of being the coordinate of the origin of the tap event.

8. The method of claim 5, wherein triangulating comprises using the amplitude differential of a tap event at a plurality of vibration sensors and linear force response approximation to triangulate the physical coordinates.

9. The method of claim 8, wherein asserting comprises adjusting for differences in physical materials and assembly by mapping amplitude differential calculation results to known surface coordinates and selecting a set of possible coordinates, wherein the set of possible coordinates are assigned a probability between 0 and 1 of being the coordinate of the origin of the tap event.

10. The method of claim 5, wherein asserting comprising detecting a time of occurrence of the tap sensor data event signal based on the recognition of tap wave form by comparing to a set of exemplary waveforms.

11. The method of claim 10, wherein recognition of the signal waveform is made using calculated characteristics of the waveform rather than the entire waveform.

12. The method of claim 5, wherein asserting comprises correlating input events using a plurality of rules to create a set of mutually supporting composite input events that include all of the data of the original events.

13. The method of claim 12, wherein correlating comprises correlating by close temporal location.

14. The method of claim 12, wherein correlating comprises correlating based on a source of the sensor data.

15. The method of claim 12 wherein correlating comprises correlating based on commonality of candidate key activations that the input event represent.

16. The method of claim 12, wherein asserting comprises removing unwanted input events from the set of input events by a plurality of filters.

17. The method of claim 16, wherein asserting comprises detecting and removing unwanted key activations resulting from the inadvertent activation of a key below an intended key.

18. The method of claim 16, wherein asserting comprises detecting and removing key activations as a result of the resting their hands on the home row position of the keyboard immediately prior to typing.

19. The method of claim 16, wherein asserting comprises detecting the selective detection and suppression of at least one of accidental or partial activations of the modifier keys to favor the most common usage of SHIFT key over CAPS LOCK.

20. The method of claim 16, wherein asserting comprises the selective detection and suppression of multiple simultaneous modifier key activations during active typing.

21. The method of claim 16, wherein asserting comprises detection of the user's typing style as either a “touch” our “hover” typist based on historical touch activation data and feeding that information back to other filtering mechanisms.

22. The method of claim 16, wherein asserting comprises translating the set of input events into a series of key up and key down activations.
